(19) United States
(12) Patent Application Publication
(10) Pub. No.: US 2019/0026923 A1
(43) Pub. Date: Jan. 24, 2019

(54) IMAGE RECOGNITION SYSTEM

(71) Applicant: DENSO CORPORATION, Kariya-city (JP)

(72) Inventor: Yosuke SHINYA, Kariya-city (JP)

(21) Appl. No.: 16/041,046

(22) Filed: Jul. 20, 2018

(30) Foreign Application Priority Data
Jul. 24, 2017 (JP) 2017-142506

(51) Int. Cl. G06T 7/73; G06T 7/80; G06T 11/60; G06K 9/00

(52) U.S. Cl. CPC G06T 7/75; G06T 7/80; G06T 2207/30252; G06K 9/00791; G06T 11/60

(57) ABSTRACT

In an image recognition system, a first image generator generates a first image based on a first directional view field. The first image has a first angle of view and a predetermined size, and a second image generator generates a second image based on a second directional view field that is at least partly different from the first directional field. The second image has a second angle of view and the same predetermined size. A recognition processor performs a recognition task of each of the first and second images using a common recognition model for the first and second images.

### CROSS REFERENCE TO RELATED APPLICATION

This application is based on and claims the benefit of priority from Japanese Patent Applications No. 2017-142506 filed on Jul. 24, 2017, the disclosure of which is incorporated in its entirety herein by reference.

### TECHNICAL FIELD

The present disclosure relates to image recognition systems for performing recognition processing of images captured based on different directional view fields; the images have different angles of view.

### BACKGROUND

Recognition processing of a captured image enables at least one target object to be detected from the captured image, and a label of at least one target, i.e. a target class, to be assigned to each pixel of the captured image. This target detection and pixel labeling have a high accuracy if the size of at least one target included in the captured image is moderated, and have a low accuracy if the size is too small or too large.

Under the above circumstances, for such recognition process, a digital zoom is often used as its preprocessing. A digital zoom is configured to crop a part of a captured image, in which a target object is predicted to be seen, and enlarge the cropped image part to a full size of the original captured image. The size of a cropped part of a captured image represents the angle of view of the cropped part or the ratio of the digital zoom.

Japanese patent application publication No. 2000-251080, which will be referred to as a first published document, discloses a monitoring apparatus. The monitoring apparatus disclosed in the first published document changes a captured image having a predetermined size and a high resolution to a first modified image maintaining the size and having a low resolution. The monitoring apparatus disclosed in the first published document also changes the captured image to a second modified image having a lower size and maintaining the high resolution.

The monitoring apparatus disclosed in the first published document selects one of the first modified image and the second modified image as an output image to be monitored.

Japanese patent application publication No. 2006-315482, which will be referred to as a second published document, discloses a moving object detection apparatus. The moving object detection apparatus determines whether a lane on which an own vehicle is travelling is adjacent to a roadway or a pathway. The moving object detection apparatus also changes an angle of view of a monitoring sensor in accordance with a result of the determination of whether the lane on which the own vehicle is travelling is adjacent to a roadway or a pathway.

### SUMMARY

For performing recognition processing of images having different angles of view, it may be necessary to prepare a plurality of recognition models for the respective images having the different angles of view. In other words, it may be difficult to perform recognition processing of images having different angles of view using a common recognition model.

From this viewpoint, the present disclosure seeks to provide image recognition systems, each of which is capable of performing recognition processing of images having different angles of view using a common recognition model.

An image recognition system according to a first exemplary aspect of the present disclosure includes a first image generator configured to generate a first image based on a first directional view field. The first image has a first angle of view and a predetermined size. The image recognition system includes a second image generator configured to generate a second image based on a second directional view field at least partly different from the first directional view field. The second image has a second angle of view and the same predetermined size. The image recognition system includes a recognition processor configured to perform a recognition task of each of the first and second images using a common recognition model for the first and second images.

An image recognition system according to a second exemplary aspect of the present disclosure includes a first image generator configured to generate a first image based on a first directional view field, and output a first output signal including the first image. The first image has a first angle of view and a predetermined size. The image recognition system includes a second image generator configured to generate a second image based on a second directional view field at least partly different from the first directional view field, and output a second output signal including the second image. The second image has a second angle of view and the same predetermined size. The image recognition system includes a recognition processor to which the first and second output signals are input, the recognition processor being configured to have a common recognition model for the first and second images.

Even if the first and second images are generated based on the different first and second directional view fields, the image recognition system according to each of the first and second exemplary aspects enables the first and second images to have the same predetermined size. This therefore enables the recognition processor to perform the recognition task of the first and second images using the common recognition model for the first and second images.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating an example of the configuration of an image recognition system according to a present embodiment of the present disclosure;

FIG. 2 is a view schematically illustrating an example where a specified clipping size is set to (1800, 1200) and a pixel reduction rate is set to 1/2;

FIG. 3 is a view schematically illustrating an example where the specified clipping size is set to (1200, 800) and the pixel reduction rate is set to 3/4;

FIG. 4 is a view schematically illustrating an example where the specified clipping size is set to (900, 600) and the pixel reduction rate is set to 1;

FIG. 5 is a view schematically illustrating an example of a situation in which an own vehicle is travelling on a leftward lane of an opposing two-lane road toward an intersection;

FIG. 6 is a view schematically illustrating a front image and a clipping region set therefor;

FIG. 7 is a view schematically illustrating a right image and a clipping region set therefor;

FIG. 8A is a perspective view schematically illustrating a first example of horizontal and vertical angle-of-view resolutions of an output image with the size of (900, 600);

FIG. 8B is a perspective view schematically illustrating a second example of the horizontal and vertical angle-of-view resolutions of an output image with the same size of (900, 600);

FIG. 8C is a perspective view schematically illustrating a third example of the horizontal and vertical angle-of-view resolutions of an output image with the same size of (900, 600);

FIG. 9 is a flowchart schematically illustrating an example of a clipping size specifying routine carried out by a clipping region specifying unit illustrated in FIG. 1;

FIG. 10 is a view schematically illustrating a target monitor range for a front camera and a target monitor range for a right camera when a vehicle is travelling on a straight road;

FIG. 11 is a view schematically illustrating a target monitor range for the right camera when the vehicle is approaching an intersection;

FIG. 12 is a view schematically illustrating target monitor ranges for the right and left cameras when the vehicle is travelling along a left-hand curve; and

FIG. 13 is a view schematically illustrating a clipping region that has shifted to the left.

### DETAILED DESCRIPTION OF EMBODIMENT

The following describes an exemplary embodiment of the present disclosure with reference to the accompanying drawings. Note that the exemplary embodiment merely represents an example of the present disclosure, and does not limit the present disclosure to the following specific configuration of the exemplary embodiment. Modification of the following specific configuration may be adopted based on the present disclosure.

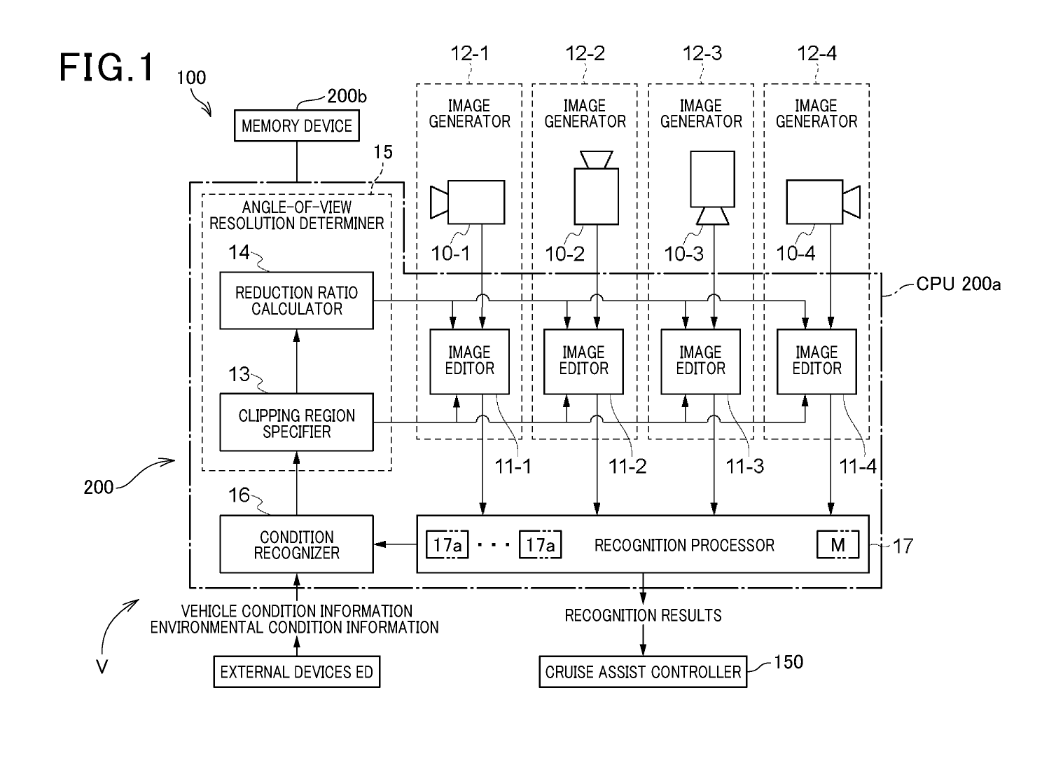

FIG. 1 schematically illustrates an example of the specific configuration of an image recognition system 100 according to the exemplary embodiment of the present disclosure. The image recognition system 100 is installed in a vehicle V.

The image recognition system 100 includes a front camera 10-1, a right camera 10-2, a left camera 10-3, and a rear camera 10-4. The front camera 10-1 is mounted to, for example, a predetermined position of the front of the vehicle V, and is directed toward the front of the vehicle V. The right camera 10-2 is mounted to, for example, a predetermined position of a right-side portion of the vehicle V, and is directed toward the right of the vehicle V. The left camera 10-3 is mounted to, for example, a predetermined position of a left-side portion of the vehicle V, and is directed toward the left of the vehicle V. The rear camera 10-4 is mounted to, for example, a predetermined position of the rear of the vehicle V, and is directed toward the rear of the vehicle V. These cameras 10-1 to 10-4 will also be collectively referred to as cameras 10, and any one of the cameras 10-1 to 10-4 will also be simply referred to as a camera 10.

In other words, the front camera 10-1 is configured to monitor a front view field relative to the vehicle V, and the right camera 10-2 is configured to monitor a right view field relative to the vehicle V. Similarly, the left camera 10-3 is configured to monitor a left view field relative to the vehicle V, and the rear camera 10-4 is configured to monitor a rear view field relative to the vehicle V. These first to fourth view fields are at least partly different from each other.

Each of the cameras 10 is configured as a digital camera; the cameras 10 respectively have imaging sensors, such as CCDs or MOS sensors, whose sizes are identical to each other. For example, each of the cameras 10 has a rectangular light-sensitive region with, for example, 1800 pixels long and 1200 pixels wide. The cameras 10 also include optical systems that have the same configuration as one another, so that the optical angles of view, i.e. the focal points, of the optical systems of the cameras 10 are set to be identical to each other. The cameras 10-1 to 10-4 respectively generate captured images each comprised of 1800 pixels long in the horizontal direction and 1200 pixels wide in the vertical direction. Note that each of the cameras 10-1 to 10-4 includes an optical zoom function.

Each of the cameras 10-1 to 10-4 is configured to capture images, i.e. frame images, at a predetermined frame rate.

The image recognition system 100 also includes image editors 11-1 to 11-4 respectively connected to the cameras 10-1 to 10-4. These image editors 11-1 to 11-4 will also be collectively referred to as image editors 11.

Each of the image editors 11-1 to 11-4 is configured to edit an image captured by the corresponding one of the cameras 10-1 to 10-4. The camera 10-1 and the image editor 11-1 constitute an image generator 12-1, and the camera 10-2 and the image editor 11-2 constitute an image generator 12-2. Similarly, the camera 10-3 and the image editor 11-3 constitute an image generator 12-3, and the camera 10-4 and the image editor 11-4 constitute an image generator 12-4. These image generators 12-1 to 12-4 will also be collectively referred to as image generators 12.

The image recognition system 100 further includes a clipping region specifying unit 13, a reduction ratio calculator 14, a condition recognizer 16, and a recognition processor 17. The clipping region specifying unit 13 and the reduction ratio calculator 14 constitute an angle-of-view resolution determiner 15.

The condition recognizer 16 is configured to recognize vehicle condition information and environmental condition information from external devices ED including sensors installed in the vehicle V, wireless communication devices installed in other vehicles located around the vehicle V, road infrastructural devices provided on roads, and/or wireless information centers provided by public or private organizations. The vehicle condition information represents how and where the vehicle V is travelling, and the environmental condition information represents environmental conditions around the vehicle V.

The recognition processor 17 is configured to perform recognition processing of images output from the respective image generators 12-1 to 12-4 to thereby recognize target objects, such as other vehicles and pedestrians, around the vehicle V. The recognition processor 17 is also configured to output the recognition results to a cruise assist controller 150.

The cruise assist controller 150 is configured to control automatic cruise or a driver's cruise of the vehicle V in accordance with the recognition results output from the recognition processor 17.

The condition recognizer 16 is also configured to obtain recognition results sent from the recognition processor 17. The specific functions of the condition recognizer 16 and the specific functions of the recognition processor 17 will be described later.

For example, at least one computer 200, which is comprised of a CPU 200a and a memory device, i.e. a storage, 200b including, for example, at least one of a RAM, a ROM, and a flash memory, is provided in the image recognition system 100 to implement the image editors 11-1 to 11-4, the clipping region specifying unit 13, the reduction ratio calculator 14, the condition recognizer 16, and the recognition processor 17.

For example, the CPU 200a of the at least one computer 200 executes at least one program stored in the memory device 200b, thus implementing functions of each of the components 11-1 to 11-4, 13, 14, 16, and 17. That is, the memory device 200b serves as a storage in which the at least one program is stored, and also serves as a working memory in which the CPU 200a performs various tasks corresponding to the respective functions.

At least two computers serving as the components 11-1 to 11-4, 13, 14, 16, and 17 can be installed in the image recognition system 100. Each of computers can include programmed hardware ICs or programmed hardware discrete circuits, such as field-programmable gate arrays (FPGA) or complex programmable logic devices (CPLD).

The clipping region specifying unit 13 specifies clipping region CR1 to CR4 in the respective captured images obtained by the cameras 10-1 to 10-4 and stored in, for example, the memory device 200b; the captured images by the respective cameras 10-1 to 10-4 will be also respectively referred to as CI1 to CI4. The clipping region in a captured image is a part or the whole part of the captured image, and has a rectangular shape including a predetermined number of pixels.

The clipping region in a captured image represents a digital angle of view relative to a corresponding camera.

Specifically, the clipping region specifying unit 13 specifies, in a captured image, a clipping reference position, for example, an upper left pixel position, of the clipping region, and specifies a clipping size, i.e. including a horizontal number x of pixels and a vertical number y of pixels, which is expressed by (x, y). That is, specifying the clipping reference position and the clipping size enables specification of the clipping region in a captured image.

In particular, the clipping region specifying unit 13 specifies the clipping regions CR1 to CR4 for the respective captured images CI1 to CI4 in accordance with the vehicle condition information and environmental condition information obtained by the condition recognizer 16. Additionally, the clipping region specifying unit 13 is configured to specify a clipping region having a constant aspect ratio of, for example, 3:2. The aspect ratio of the clipping region represents a proportional relationship of the clipping region between its horizontal width and its vertical height.

The reduction ratio calculator 14 calculates a reduction ratio of pixels of each of the clipping regions CR1 to CR4 in accordance with, for example, the corresponding clipping size specified by the clipping region specifying unit 13. The reduction ratio of pixels, i.e. the pixel reduction ratio, for a clipping region represents the ratio of the number of remaining pixels within the clipping region to all the pixels of the clipping region after reduction of pixels from the clipping region by the image editor 11. For example, the pixel reduction ratio set to 1/2 represents the half of all the pixels remaining within the clipping region after reduction of pixels from the clipping region.

In particular, the reduction ratio calculator 14 calculates the pixel reduction ratio of each of the clipping regions CR1 to CR4 such that the size, i.e. the number of pixels, of each of the output images obtained by the image editors 11-1 to 11-4 is identical to the size, i.e. the number of pixels, of any of the other output images independently of the specified clipping sizes of the clipping regions.

Each of the image editors 11-1 to 11-4 clips the corresponding one of the clipping regions CR1 to CR4 specified by the clipping region specifying unit 13 from the corresponding one of the captured images CI1 to CI4. Then, each of the image editors 11-1 to 11-4 reduces pixels from the corresponding one of the clipping regions CR1 to CR4 in accordance with the corresponding pixel reduction ratio calculated by the reduction ratio calculator 14, thus reducing the size of the corresponding one of the clipping regions CR1 to CR4.

Specifically, each of the image editors 11-1 to 11-4 is configured to thin the corresponding one of the clipping regions CR1 to CR4 based on the corresponding pixel reduction ratio to thereby remove selected pixels based on the corresponding pixel reduction ratio from the corresponding one of the clipping regions CR1 to CR4. Then, each of the image editors 11-1 to 11-4 is configured to combine the remaining pixels of the corresponding one of the clipping regions CR1 to CR4 to thereby generate an output image that has a predetermined size identical to a size of any of the other output images.

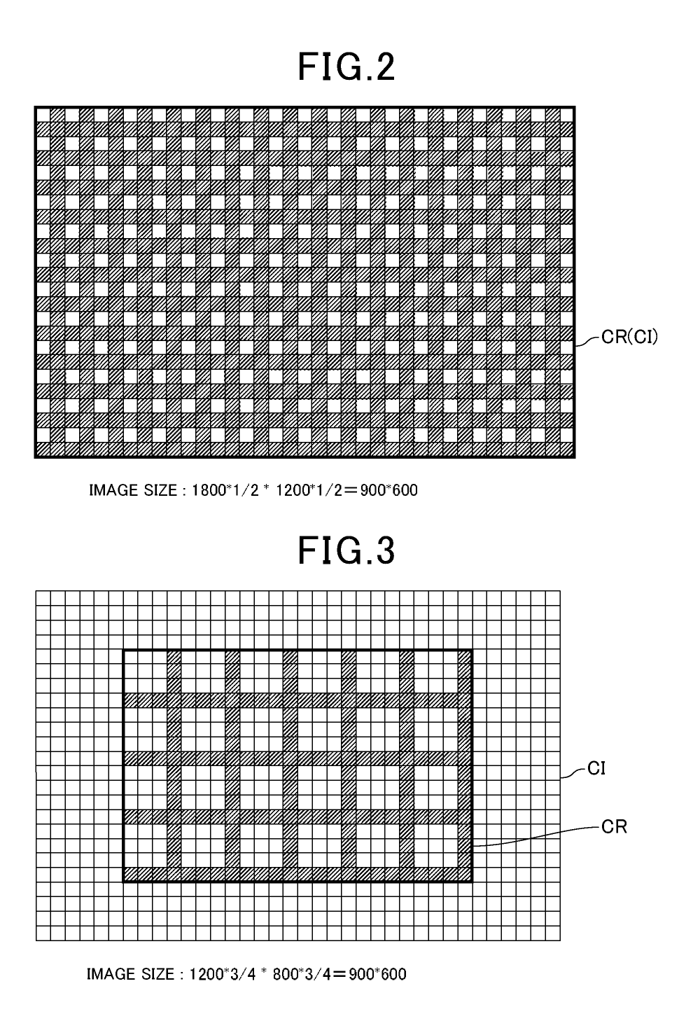

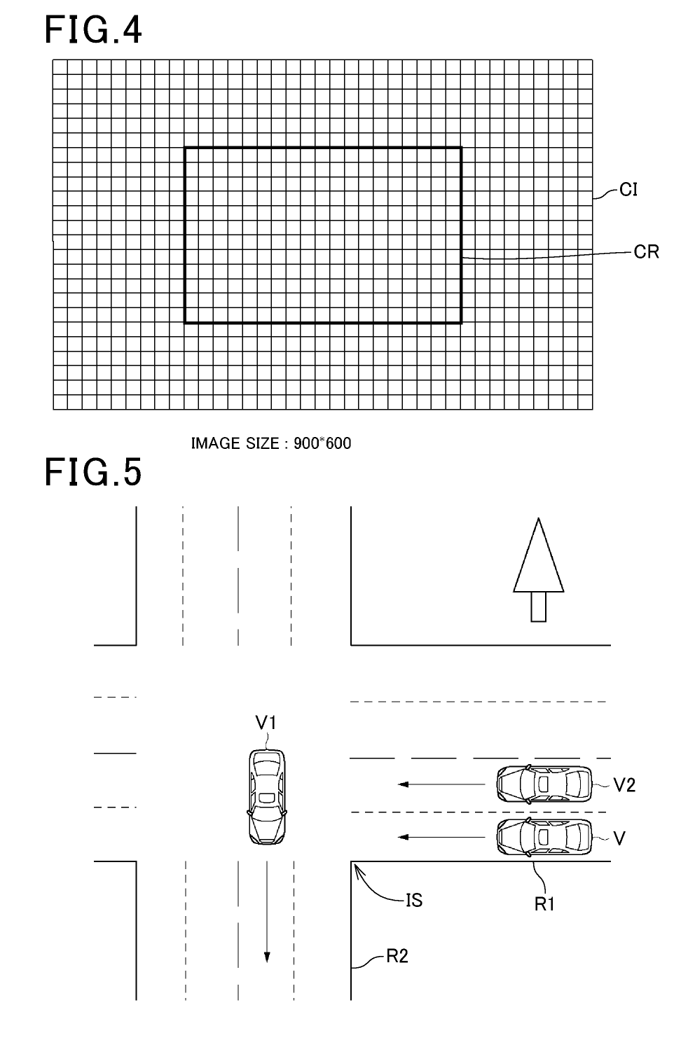

Each of FIGS. 2 to 4 shows an example of the relationship between a specified clipping size of a specified clipping region CR and a calculated pixel reduction ratio for the clipping region CR. In each of FIGS. 2 to 4, hatched pixels represent pixels to be removed from the clipping region CR by a corresponding one of the image editors 11-1 to 11-4. In each of FIGS. 2 and 4, an output image finally obtained by each of the image editors 11-1 to 11-4 is comprised of 900 pixels long and 600 pixels wide, which is expressed by a size of (900, 600).

That is, each of FIGS. 2 to 4 illustrates an editing task carried out by each image editor 11. The editing task is configured to edit the captured image CI having the size of (1800, 1200) and stored in the memory device 200b to thereby generate the output image having the target size of (900, 600).

FIG. 2 illustrates an example where the specified clipping size is set to (1800, 1200), that is, the whole of the captured image is clipped. In this example, each image editor 11 is configured to clip, from the captured image CI with the size of (1800, 1200), the clipping region CR with the size of (1800, 1200), and thin the clipping region CR with the size of (1800, 1200) to thereby remove the hatched pixels from the clipping region CR by the pixel reduction ratio of 1/2. This enables the output image, which has the target size of (900, 600), to be obtained from the clipping region CR with the size of (1800, 1200); the size (1800, 1200) of the clipping region CR represents a corresponding digital angle of view relative to the corresponding camera.

FIG. 3 illustrates an example where the specified clipping size is set to (1200, 800). In this example, each image editor 11 is configured to clip, from the captured image CI with the size of (1800, 1200), the clipping region CR with the size of (1200, 800), and thin the clipping region CR with the size of (1200, 800) to thereby remove the hatched pixels from the clipping region CR by the pixel reduction ratio of 3/4. This enables the output image, which has the target size of (900, 600), to be obtained from the clipping region CR with the size of (1200, 800); the size (1200, 800) of the clipping region CR represents a corresponding digital angle of view relative to the corresponding camera.

FIG. 4 illustrates an example where the specified clipping size is set to (900, 600). In this example, each image editor 11 is configured to clip, from the captured image CI with the size of (1800, 1200), the clipping region CR with the size of (900, 600). Because the clipping region CR has the target size of (900, 600), each image editor 11 is configured not to perform the thinning task set forth above. That is, the pixel reduction ratio is set to 1. This enables the output image, which has the target size of (900, 600), to be obtained from the clipping region CR with the size of (900, 600); the size (900, 600) of the clipping region CR represents a corresponding digital angle of view relative to the corresponding camera.

FIG. 5 schematically illustrates an example of the situation in which the own vehicle V is travelling on a leftward lane of an opposing two-lane road R1 toward an intersection IS where the road R1 crosses an opposing two-lane road R2. In addition, a first other vehicle V1 is travelling in the intersection IS, and a second other vehicle V2 is travelling on the rightward lane, which is the adjacent lane to the leftward lane, of the road R1 toward the intersection IS in parallel with the own vehicle V.

That is, the front camera 10-1 of the own vehicle V is capable of capturing a front image including the first other vehicle V1, and the right camera 10-2 of the own vehicle V is capable of capturing a right image including the second other vehicle V2. Referring to FIG. 5, the first other vehicle V1 is located at a relatively long distance from the own vehicle V, and the second other vehicle V2 is located at a relatively short distance from the own vehicle V.

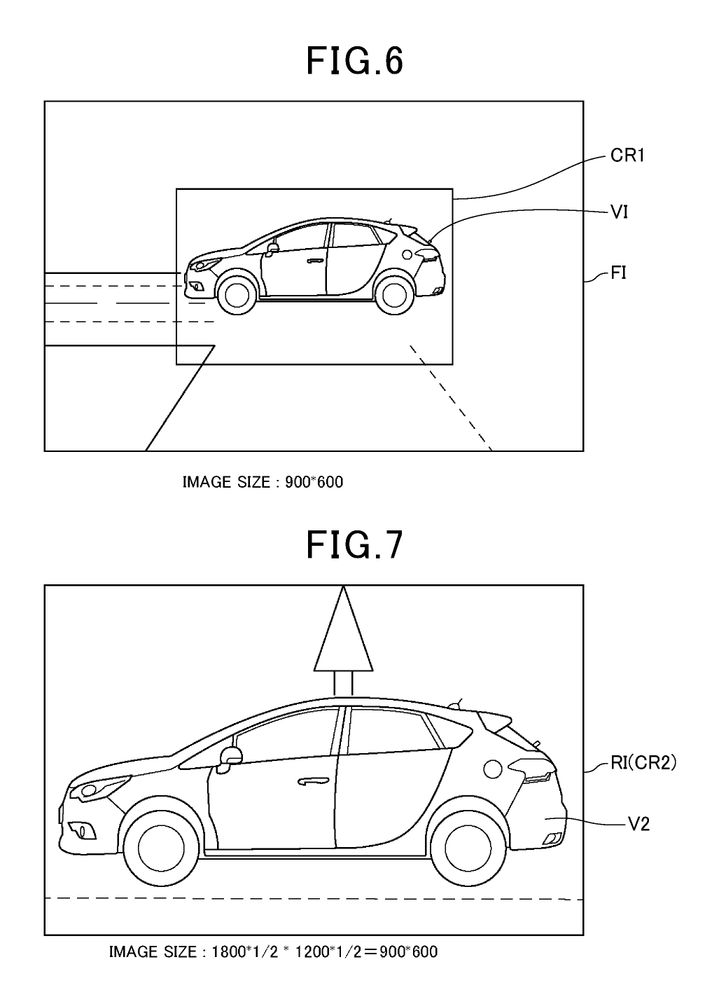

FIG. 6 illustrates the front image (see reference character FI) captured by the front camera 10-1, and FIG. 7 illustrates the right image (see reference character RI) obtained by the right camera 10-2. Because the first other vehicle V1 is located at a relatively long distance from the own vehicle V, the first other vehicle V1 appearing in the front image FI has a relatively small scale. In contrast, because the second other vehicle V2 is located at a relatively short distance from the own vehicle V, the second other vehicle V2 appearing in the right image RI has a relatively large scale.

When assuming that the first other vehicle V1 captured by the front camera 10-1 is located at a relatively long distance from the own vehicle V, the clipping region specifying unit 13 specifies, as the clipping size of the clipping region CR1 for the image editor 11-1, a relatively small clipping size.

In the example illustrated in FIG. 6, the clipping region specifying unit 13 specifies, as the clipping size of the clipping region CR1 for the image editor 11-1, a minimum size of (900, 600). This enables the first other vehicle V1, which appears to be relatively small in the captured front image FI, to appear to be relatively large within the clipping region CR1.

In contrast, in the example illustrated in FIG. 7, the clipping region specifying unit 13 specifies, as the clipping size of the clipping region CR2 for the image editor 11-2, a full size of (1800, 1200) that is the same size of the captured right image RI. This enables the second other vehicle V2, which appears to be relatively large in the captured right image RI, to appear to be relatively large within the clipping region CR2.

Specifically, the clipping region specifying unit 13 is configured to set the clipping size of the clipping region CR for each image editor 11 to a relatively small size for each image editor 11 when assuming that a corresponding target object, such as the corresponding other vehicle, is located at a relatively long distance from the own vehicle V. This setting of the clipping size of the clipping region CR to a smaller size will also be referred to as a zoom-in task.

In contrast, the clipping region specifying unit 13 is configured to set the clipping size of the clipping region CR for each image editor 11 to a relatively large size when assuming that a corresponding target object, such as the corresponding other vehicle, is located at a relatively short distance from the own vehicle V. This setting of the clipping size of the clipping region CR to a larger size will also be referred to as a zoom-out task.

Note that the ratio of the number of each of horizontal and vertical pixels of a captured image, i.e. a full size, to the number of the corresponding pixels of a clipping region represents a zoom factor. For example, the clipping region CR with the size of (900, 600) has a 2× zoom factor.

As described above, if the distance to a first target object appearing in, for example, the front image from the own vehicle V is longer than the distance to a second target object appearing in, for example, the right image from the own vehicle V, the clipping region specifying unit 13 is configured to set the clipping size of the clipping region CR1 for the front image to be smaller than the clipping size of the clipping region CR2 for the right image. This results in the size of the clipping region CR1 being smaller than the size of the clipping region CR2.

From this viewpoint, the reduction ratio calculator 14 is configured to calculate, as described above, the pixel reduction ratio of each of the clipping regions CR1 and CR2 in accordance with the clipping size of the corresponding one of the clipping regions CR1 and CR2. This enables each of the image editors 11-1 and 11-2 to thin the corresponding one of the clipping regions CR1 and CR2 based on the corresponding one of the pixel reduction ratios such that the size, i.e. the number of pixels, of each of the output images obtained by the image editors 11-1 and 11-2 is identical to the size, i.e. the number of pixels, of any of the other output images.

This therefore results in the size of the output image obtained by the image editor 11-1 being identical to the size of the output image obtained by the image editor 11-2 independently of the specified clipping sizes of the clipping regions CR1 and CR2.

As described above, each of the image generators 12-1 to 12-4 is configured to cause the corresponding one of the image editors 11-1 to 11-4 to

(1) Clip, from an image captured by the corresponding one of the cameras 10-1 to 10-4 and stored in the memory device 200b, a clipping region having a clipping size specified by the clipping region specifying unit 13

(2) Thin the corresponding clipping region by the pixel reduction ratio determined based on the corresponding clipping region on the memory device 200b to thereby match the size of the corresponding output image with the size of any of the other output images

This results in the image generators 12-1 to 12-4 respectively generating the output images that have the same size and respective angle-of-view resolutions that are determined based on the clipping sizes of the respective clipping regions.

That is, the image generators 12-1 to 12-4 are configured to generate output images having the same size and having respective angle-of-view resolutions determined based on the clipping sizes of the respective clipping regions; the clipping sizes of the respective clipping regions represent respective digital angles of view of the respective clipping regions. If the clipping size of one of the clipping regions is equal to the clipping size of another one of the clipping regions, the angle-of-view resolution of the output image based on one of the clipping regions is set to be identical to the angle-of-view of the output image based on another one of the clipping regions.

The angle-of-view resolution of an output image generated by each of the image generators 12-1 to 12-4 is defined as the number of pixels of the output image per a unit angle of view of the corresponding clipping region with respect to a camera 10.

The present embodiment can use one of a horizontal angle-of-view resolution, a vertical angle-of-view resolution, and a diagonal angle-of-view resolution as the angle-of-view resolution.

More specifically, the horizontal angle-of-view resolution of an output image generated by each of the image generators 12-1 to 12-4 is defined as the number of pixels of the output image per a unit angle of view of the number of pixels of the corresponding clipping region in the horizontal direction with respect to a camera 10. Similarly, the vertical angle-of-view resolution of an output image generated by each of the image generators 12-1 to 12-4 in the vertical direction is defined as the number of pixels of the output image per a unit angle of view of the number of pixels of the corresponding clipping region in the vertical direction with respect to a camera 10.

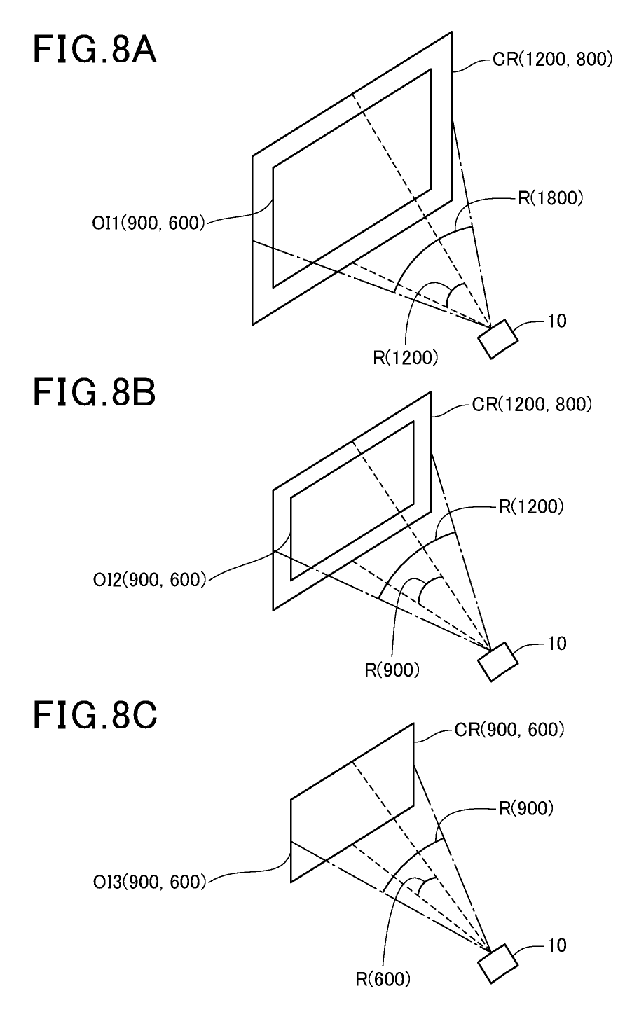

For example, FIG. 8A illustrates that the horizontal and vertical angle-of-view resolutions of an output image OI1 having the size of (900, 600) obtained from the clipping region CR having the size of (1800, 1200) for a camera 10.

That is, the horizontal angle-of-view resolution of the output image OI1 is defined as 900/R(1800); R(1800) represents the unit angle of view of 1800 pixels between opposing right and left edges of the clipping region CR with respect to the camera 10.

Additionally, FIG. 8A illustrates that the vertical angle-of-view resolution of the output image OI1 is defined as 600/R(1200); R(1200) represents the unit angle of view of 1200 pixels between the top and bottom of the clipping region CR with respect to the camera 10.

Similarly, FIG. 8B illustrates the horizontal and vertical angle-of-view resolutions of an output image OI2 having the size of (900, 600) obtained from the clipping region CR having the size of (1200, 800) for a camera 10.

That is, the horizontal angle-of-view resolution of the output image OI2 is defined as 900/R(1200); R(1200) represents the unit angle of 1200 pixels between the opposing left and right edges of the clipping region CR with respect to the camera 10.

Additionally, FIG. 8B illustrates that the vertical angle-of-view resolution of the output image OI2 is defined as 600/R(800); R(800) represents the unit angle of view of 800 pixels between the top and bottom of the clipping region CR with respect to the camera 10.

FIG. 8C illustrates the horizontal and vertical angle-of-view resolutions of an output image OI3 having the size of (900, 600) obtained from the clipping region CR having the size of (900, 600) for a camera 10.

That is, the horizontal angle-of-view resolution of the output image OI3 is defined as 900/R(900); R(900) represents the unit angle of view of 900 pixels between opposing right and left edges of the clipping region CR with respect to the camera 10.

Additionally, FIG. 8C illustrates that the vertical angle-of-view resolution of the output image OI3 is defined as 600/R(600); R(600) represents the unit angle of view of 600 pixels between the top and bottom of the clipping region CR with respect to the camera 10.

The clipping size of each of the clipping regions CR1 to CR4 according to the present embodiment represents the digital angle of view of the corresponding clipping region. For this reason, the horizontal angle-of-view resolution of an output image generated by each of the image generators 12-1 to 12-4 can be defined as the ratio of the number of pixels of the output image to the number of pixels of the clipping size in the horizontal direction. Similarly, the vertical angle-of-view resolution of an output image generated by each of the image generators 12-1 to 12-4 can be defined as the ratio of the number of pixels of the output image to the number of pixels of the clipping size in the vertical direction.

A diagonal angle-of-view resolution of an output image generated by each of the image generators 12-1 to 12-4 in the diagonal line can also be defined as the number of pixels of the output image per a unit angle of view of the number of pixels of the corresponding clipping region in the diagonal line with respect to a camera 10.

The horizontal angle-of-view resolution, the vertical angle-of-view resolution, and the diagonal angle-of-view resolution of an output image generated by each of the image generators 12-1 to 12-4 are set to be identical to each other.

The following describes the horizontal angle-of-view resolution of an output image generated by each of the image generators 12-1 to 12-4 is representatively used as the angle-of-view resolution of the output image.

As seen by the definition of the angle-of-view resolution of an output image, the angle-of-view resolution of the output image is proportional to the pixel reduction ratio of the clipping region for the output image. This results in the output images, which respectively have the different angle-of-view resolutions, being generated from the corresponding clipping regions by the respectively different pixel reduction ratios.

In other words, specifying the clipping regions CR1 to CR4 for the respective captured images CI1 to CI4 and calculating the pixel reduction ratio for each of the clipping regions CR1 to CR4 enable the angle-of-view resolution for the corresponding one of the clipping regions CR1 to CR4 to be determined. That is, the clipping region specifying unit 13 and the reduction ratio calculator 14 constitute the angle-of-view resolution determiner 15 for determining the angle-of-view resolution for each of the image generators 12-1 to 12-4.

To sum up, the angle-of-view resolution determiner 15 is configured to

1. Determine the clipping regions CR1 to CR4 for the respective cameras 10-1 to 10-4 in accordance with the vehicle condition information and environmental condition information obtained by the condition recognizer 16

2. Calculate the pixel reduction ratios for the respective clipping regions CR1 to CR4

3. Determine the angle-of-view resolution for each of the output images in accordance with the corresponding one of the clipping regions CR1 to CR4 and the corresponding one of the pixel reduction ratios

Next, the following describes how the clipping region specifying unit 13 specifies the clipping regions CR1 to CR4 for the respective cameras 10-1 to 10-4 in accordance with the vehicle condition information and environmental condition information obtained by the condition recognizer 16.

The clipping region specifying unit 13, i.e. the CPU 200a, is configured to execute a clipping size specifying routine in accordance with the at least one program stored in the memory device 200b every predetermined period. Hereinafter, one clipping size specifying routine periodically performed by the clipping region specifying unit 13 will be referred to as a cycle.

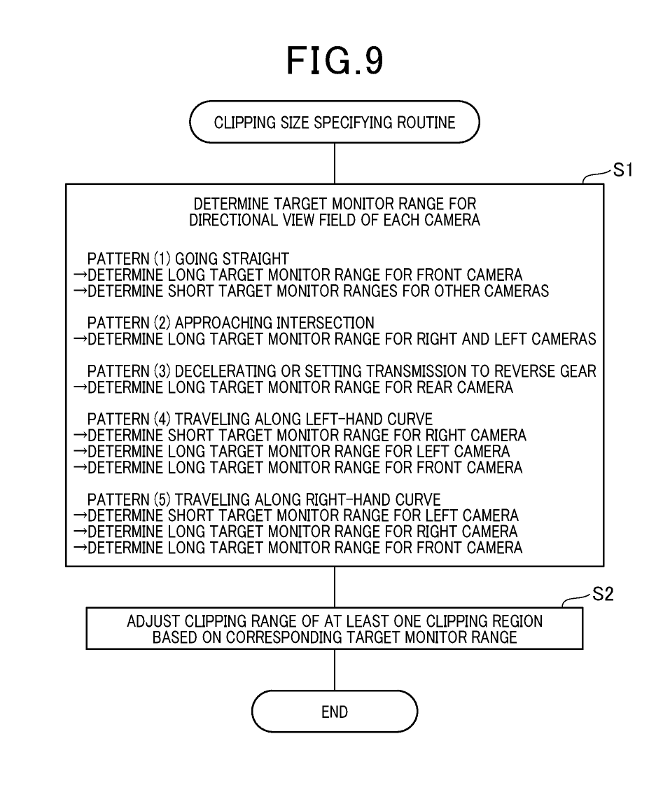

Upon starting a current cycle of the clipping size specifying routine, the clipping region specifying unit 13 determines a target monitor range for the directional view field of each of the cameras 10-1 to 10-4 in accordance with the vehicle condition information and environmental condition information obtained by the condition recognizer 16 in step S1 of FIG. 9.

That is, in step S1, the clipping region specifying unit 13 can determine different target monitor ranges for the respective directional view fields of the cameras 10-1 to 10-4 in accordance with the vehicle condition information and environmental condition information obtained by the condition recognizer 16.

Next, in step S2, the clipping region specifying unit 13 adjusts the clipping size and/or the clipping reference position of at least one of the clipping regions CR1 to CR4 in accordance with the corresponding at least one of the target monitor ranges determined in step S1, the vehicle condition information, and environmental condition information obtained by the condition recognizer 16.

For example, in step S2, the clipping region specifying unit 13 sets the clipping size of a clipping region to be smaller with the corresponding target monitor range becoming longer, and the clipping size of a clipping region to be larger with the corresponding target monitor range becoming shorter.

In other words, in step S2, the clipping region specifying unit 13 sets the clipping size of a clipping region in the clipping regions CR1 to CR4 to be smaller than the clipping size of an alternate clipping region in the clipping regions CR1 to CR4 if the target monitor range of the clipping region is longer than the target monitor range of the alternate clipping region.

Note that increasing the clipping size of a clipping region results in the corresponding digital angle of view becoming larger and the corresponding zoom factor becoming smaller, and decreasing the clipping size of a clipping region results in the corresponding digital angle of view becoming smaller and the corresponding zoom factor becoming larger.

The following describes specific examples of how to determine the clipping size of each of the clipping regions CR1 to CR4.

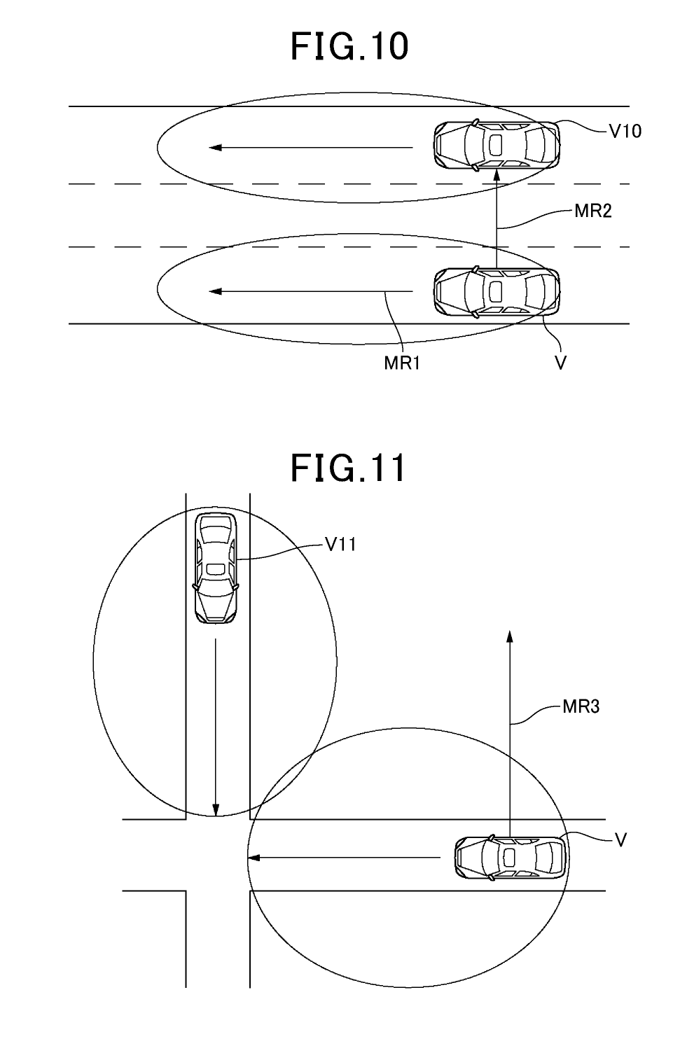

FIG. 10 schematically illustrates an example where the vehicle V is travelling on one lane in a two-lane straight road, such as an express way, while an adjacent vehicle V10 is travelling on the other lane in the two-lane straight road. At that time, the condition recognizer 16 obtains, from, for example, a speed sensor included in the external devices ED, a speed of the vehicle V, and obtains, from, for example, a steering sensor included in the external devices ED, information indicative of whether the vehicle V is traveling straight. When recognizing that the vehicle V is travelling straight at a higher speed than a predetermined threshold speed, the condition recognizer 16 sends the recognition result to the clipping region specifying unit 13.

Then, the clipping region specifying unit 13 determines a longer target monitor range MR1 for the front camera 10-1, and determines a shorter target monitor range MR2 for each of the remaining cameras 10-2 to 10-4 (see Pattern (1) in step S1).

In this example, the clipping region specifying unit 13 sets the clipping size of the clipping region CR1 for the front camera 10-1 to a relatively small size with the corresponding digital angle of view being a relatively small value and the corresponding zoom factor being a relatively large value (see step S2).

Additionally, the clipping region specifying unit 13 sets the clipping size of each of the other clipping regions CR2 to CR4 for the corresponding one of the cameras 10-2 to 10-4 to a relatively large size with the corresponding digital angle of view being a relatively large value and the corresponding zoom factor being a relatively small value (see step S2).

Because the vehicle V is travelling on the straight road without intersections and crossroads, other vehicles are unlikely to be approaching laterally perpendicular to the travelling direction of the vehicle V at a relatively high speed. For this reason, the clipping region specifying unit 13 sets the clipping size of each of the clipping regions CR2 and CR3 for the corresponding right and left cameras 10-2 and 10-3 to a relatively large size.

FIG. 11 schematically illustrates an example where the vehicle V is travelling on a road, and approaching an intersection IN. At that time, the condition recognizer 16 obtains, from, for example, a navigation system included in the external devices ED, the current location of the vehicle V and graphic data of road maps, and recognizes that the vehicle V is approaching the intersection IN. Alternatively, when the recognition results sent from the recognition processor 17 include traffic lights, the condition recognizer 16 recognizes that the vehicle V is approaching the intersection IN. Note that a vehicle V11 is approaching the intersection IN.

Then, the condition recognizer 16 sends the recognition result to the clipping region specifying unit 13.

Then, the clipping region specifying unit 13 determines a longer target monitor range MR3 for each of the right and left cameras 10-2 and 10-3 (see Pattern (2) in step S1).

In this example, the clipping region specifying unit 13 sets the clipping size of each of the clipping regions CR2 and CR3 for the right and left cameras 10-2 and 10-3 to a relatively small size (see step S2).

For example, the clipping region specifying unit 13 sets the clipping size of each of the clipping regions CR2 and CR3 to be smaller than the clipping size of the corresponding one of the clipping regions CR2 and CR3 for the example illustrated in FIG. 10.

Additionally, the clipping region specifying unit 13 increases the clipping size of each of the front and rear clipping regions CR1 and CR4 with a reduction of the speed of the vehicle V.

Because the vehicle V is approaching the intersection IN, there are possibility of other vehicles approaching from the left side of the travelling direction of the vehicle V at a relatively high speed. For this reason, the clipping region specifying unit 13 sets the clipping size of the clipping region CR3 for the left camera 10-3 to a relatively small size. This enables the other vehicles approaching from the left side of the travelling direction of the vehicle V at a relatively high speed to be detected earlier.

When the condition recognizer 16 recognizes, from, for example, a brake sensor in the external devices ED, that the vehicle V is decelerating or recognizes, from, for example, a shift lever in the external devices ED, that the transmission of the vehicle V is set to a reverse gear position, the condition recognizer 16 sends the recognition result to the clipping region specifying unit 13.

Then, the clipping region specifying unit 13 determines a longer target monitor range for the rear camera 10-4 other than a target monitor range for each of the remaining cameras 10-1 to 10-3 (see Pattern (3) in step S1).

In this example, the clipping region specifying unit 13 sets the clipping size of the clipping region CR4 for the rear camera 10-4 to a relatively small size (see step S2).

While the vehicle V is decelerating or is reversing, it is important for safety to watch out for other vehicles approaching from the rear side of the vehicle V at a relatively high speed. From this viewpoint, setting the clipping size of the clipping region CR4 for the rear camera 10-4 to a relatively small size enables the other vehicles approaching from the rear side of the vehicle V at a relatively high speed to be detected earlier.

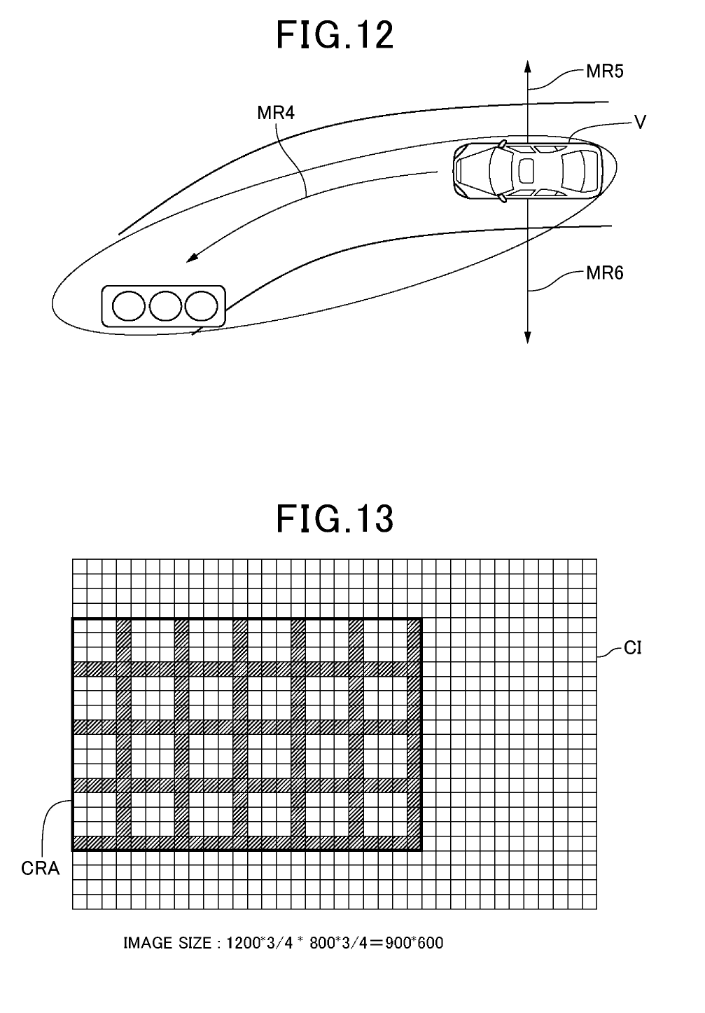

FIG. 12 schematically illustrates an example where the vehicle V is travelling along a left-hand curve. At that time, the condition recognizer 16 obtains, from the speed sensor, the speed of the vehicle V, and obtains, from the steering sensor, a steering angle of a steering wheel of the vehicle V.

When recognizing that the speed of the vehicle V is higher than the predetermined threshold speed and the left-hand steering angle is equal to or higher than a predetermined threshold angle, the condition recognizer 16 sends, to the clipping region specifying unit 13, the recognition result that the vehicle V is travelling on a left-hand curve.

When receiving the recognition result, the clipping region specifying unit 13 determines a longer target monitor range MR4 that is inclined leftward for the front camera 10-1, determines a shorter target monitor range MR5 for the right camera 10-2, and determines a longer target monitor range MR6 for the left camera 10-3 (see Pattern (4) in step S1).

Then, the clipping region specifying unit 13 sets the clipping size of the clipping region CR2 for the right camera 10-2 to a relatively large size (see step S2), and sets the clipping size of each of the remaining clipping regions CR1, CR3, and CR4 for the front, left, and rear cameras 10-1, 10-3, and 10-4 to a relatively small size (see step S2).

In particular, in step S2, the condition recognizer 16 sends, to the clipping region specifying unit 13, the recognition result that the vehicle V is travelling on a left-hand curve. For this reason, the clipping region specifying unit 13 shifts the clipping reference position, i.e. the upper left pixel position, of the clipping region CR (see FIG. 3) to the left, so that the clipping region CRA has shifted to the left (see FIG. 13) if the clipping size of the clipping region CR1 is set to (1200, 800).

Specifically, the clipping region specifying unit 13 is capable of variably adjusting the clipping reference position of the clipping region CR in accordance with the vehicle condition information and environmental condition information obtained by the condition recognizer 16.

That is, if the vehicle V is travelling along a left-hand curve, it is important for safety to watch out for objects behind the left-hand curve. For this reason, setting the clipping size of each of the clipping region CR1 for the front camera 10-1 and the clipping region CR3 for the left camera 10-3 to a relatively small size enables other vehicles appearing behind the left-hand curve to be detected earlier.

When the vehicle V is travelling along a right-hand curve, the clipping region specifying unit 13 determines a longer target monitor range that is inclined rightward for the front camera 10-1, determines a shorter target monitor range for the left camera 10-3, and determines a longer target monitor range for the right camera 10-2 (see Pattern (5) in step S1).

Then, the clipping region specifying unit 13 sets the clipping size of the clipping region CR3 for the left camera 10-3 to a relatively large size (see step S2), and sets the clipping size of each of the remaining clipping regions CR1, CR2, and CR4 for the front, right, and rear cameras 10-1, 10-2, and 10-4 to a relatively small size (see step S2).

In particular, in step S2, the clipping region specifying unit 13 shifts the clipping reference position, i.e. the upper left pixel position, of the clipping region CR1 to the right, thus shifting the clipping region CR1 to the right as compared with the clipping region CR illustrated in FIG. 3 if the clipping size of the clipping region CR1 is set to (1200, 800).

That is, if the vehicle V is travelling along a right-hand curve, it is safely important to watch out for objects behind the right-hand curve. For this reason, setting the clipping size of each of the clipping region CR1 for the front camera 10-1 and the clipping region CR2 for the right camera 10-2 to a relatively small size enables other vehicles appearing behind the right-hand curve to be detected earlier.

The condition recognizer 16 obtains, from, for example, a radar device included in the external devices ED, the speed of one or more other vehicles located around the vehicle V as environmental information around the vehicle V. The condition recognizer 16 can be configured to determine whether each of the other vehicles is travelling on a public highway or an express way in accordance with the current location of each of the other vehicles and graphic data of road maps. Then, the condition recognizer 16 can be configured to regard the speed of each of the other vehicles as 50 km/h when the corresponding other vehicle is travelling on a public highway, and regard the speed of each of the other vehicles as 80 km/h when the corresponding other vehicle is travelling on an express highway. When the recognition results sent from the recognition processor 17 include a traffic sign indicative of a predetermined speed limit, the condition recognizer 16 can determine the speed of each of the other vehicles as a function of the speed limit.

The condition recognizer 16 is capable of recognizing, based on, for example, the steering angle of the steering wheel measured by the steering sensor, that the vehicle V is turning or is about to be turning right or left at an intersection.

The condition recognizer 16 is capable of determining that the vehicle V is about to be turning right or left in accordance with whether a right blinker or a left blinker included in the external devices ED is operating. The condition recognizer 16 is also capable of recognizing that the vehicle V is turning or is about to be turning right or left in accordance with a guided route and the current location of the vehicle V obtained from the navigation system included in the external devices ED.

The condition recognizer 16 is capable of recognizing there is at least one traffic light and/or at least one traffic sign in accordance with the recognition results sent from the recognition processor 17. If it is recognized that there is at least one traffic light and/or at least one traffic sign, the clipping region specifying unit 13 is capable of adjusting the clipping size of at least one of the clipping regions CR1 to CR4 to thereby cause the at least one of the clipping regions CR1 to CR4 to enclose the whole of the at least one traffic light and/or at least one traffic sign. As another example, the condition recognizer 16 is capable of recognizing there is at least one traffic light and/or at least one traffic sign in accordance with the current location of the vehicle V and the graphic data of road maps. If it is recognized that there is at least one traffic light and/or at least one traffic sign, the clipping region specifying unit 13 is capable of adjusting the clipping size of at least one of the clipping regions CR1 to CR4 to thereby cause the at least one of the clipping regions CR1 to CR4 to enclose the whole of the at least one traffic light and/or at least one traffic sign.

The recognition processor 17 includes a single recognition model M stored in, for example, the memory device 200b, and performs a predetermined recognition task based on the recognition model M and the output images sent from the respective image generators 12-1 to 12-4; the output images have the same size of (900, 600). That is, as described above, the output images, which have the same size of (900, 600) and have individually adjusted angle-of-view resolutions, are generated by the respective image generators 12-1 to 12-4, and are input to the recognition processor 17.

At that time, because the output images subjected to the recognition task by the recognition processor 17 have a uniform size, making it possible to perform the predetermined recognition task using the common recognition model M.

The recognition processor 17 according to the present embodiment employs a common machine learning model as the recognition model M. In particular, the recognition processor 17 for example uses a common deep neural network model.

For example, the recognition processor 17 is capable of, using the common deep neural network model, performing at least one of a detection task that detects at least one target object and generates a rectangular bounding box each target object, and a pixel labeling task, such as sematic segmentation, depth estimation, or boundary estimation.

The pixel labeling task is configured to

1. Convert each of the output images into intermediate features

2. Convert the intermediate features into output features; the output features represent predetermined category labels of each pixel in each of the output images

3. Extract plural segments by uniting the pixels, which have the same category label, to thereby recognize categories and shapes of target objects corresponding to the respective segments

The output features can also represent distance values between the own vehicle V and target objects in each pixel, and boundaries between different categories or between different target objects.

Each of the image editor 11, the angle-of-view resolution determiner 15, and the recognition processor 17 can be configured to use a sliding window approach or use fully convolutional networks (FCNs). Although an arbitrary size of images input to the FCNs, it is necessary to input the unified size of images to a part of the FCNs.

The recognition processor 17 can use a known support vector machine or a decision tree algorithm.

In particular, the recognition model M of the recognition processor 17 according to the present embodiment is configured to perform the recognition task for each of the output images that are obtained by the respective cameras 10-1 to 10-4 having respectively different directional view fields while being trained. That is, the output images that are obtained by the respective cameras 10-1 to 10-4 having respectively different directional view fields enable the recognition model M to be trained.

As a method of training the recognition model M, an ensemble of plural training results, each of which has been obtained based on images captured by the corresponding one of the cameras 10-1 to 10-4, can obtain a trained common recognition model M. The recognition model M created set forth above can be compressed by knowledge distillation.

Note that, as described above, it is preferable to train the recognition model M using the output images based on respectively different directional view fields. In particular, it is preferable to train the recognition model M using the output images that are obtained by the respective cameras 10-1 to 10-4 having all-around view fields. It is however possible to train the recognition model M using the output images based on a single directional view field.

As described above, the image recognition system 100 according to the present embodiment includes the cameras 10-1 to 10-4 monitoring respectively different directional view fields relative to the vehicle V. The image recognition system 100 also includes the recognition processor 17 configured to perform the recognition task for each of the images captured from the respective cameras 10-1 to 10-4.

In particular, the image recognition system 100 is configured to clip a clipping region from each of the captured images; the clipping region is estimated to enclose at least one of target objects. This clipping aims to improve the recognition efficiently of at least one of the target objects for each of the captured images.

In particular, the image recognition system 100 is configured to

1. Clip, from each of the images captured by the respective cameras 10-1 to 10-4, a corresponding one of the clipping regions CR1 to CR4

2. Thin each of the clipping regions CR1 to CR4 based on a corresponding pixel reduction ratio calculated for the clipping size of the corresponding one of the clipping regions CR1 to CR4

This makes it possible to adjust the size of each of the output images for the respective image generators 12-1 to 12-4 such that the output images have the same size independently of the sizes of the clipping regions CR1 to CR4.

This configuration therefore eliminates the need to prepare a plurality of recognition models for the different sizes of the clipping regions CR1 to CR4, thus reducing

1. The cost needed to prepare the plurality of recognition models for the different sizes of the clipping regions CR1 to CR4

2. The training time needed to train all the recognition models

3. The inference time needed for each of the plurality of recognition models to make an inference

4. The storage capacity of the memory device 200b needed to store the plurality of recognition models

5. The time needed to verify the operations of each of the plurality of recognition models

In addition, the image recognition system 100 is configured to

(1) Determine target monitor ranges for the respective directional view fields of the cameras 10-1 to 10-4 in accordance with vehicle condition information and environmental condition information obtained by the condition recognizer 16

(2) Adjust the clipping size and/or the clipping reference position of at least one of the clipping regions CR1 to CR4 in accordance with the corresponding at least one of the target monitor ranges, the vehicle condition information, and environmental condition information obtained by the condition recognizer 16

This configuration enables at least one target object seen in the at least one of the clipping regions CR1 to CR4 to be relatively large, making it possible to improve the recognition accuracy of the at least one target object.

Note that the image recognition system 100 according to the present embodiment is configured to execute, for each of the image generators 12-1 to 12-4, an editing task that

1. Clip, from the corresponding captured image, a corresponding clipping region

2. Thin, if necessary, the corresponding clipping region specified by the clipping region specifying unit 13 from the corresponding captured image

The present disclosure is however not limited to this configuration.

Specifically, the size of the clipping region for at least one of the image editors 11-1 to 11-4 can be fixed, and the corresponding pixel reduction ratio can also be fixed.

The image recognition system 100 according to the present embodiment obtains, based on the clipping task and the thinning task, the output image having the size of (900, 600) from the captured image having the size of (1800, 1200). At that time, if the light-sensitive region of one of the cameras 10-1 to 10-4 has the size of (900, 600), the image editor corresponding to one of the cameras 10-1 to 10-4 can be eliminated.

The image recognition system 100 according to the present embodiment includes the four cameras 10-1 to 10-4 monitoring respectively different directional view fields relative to the vehicle V. The number of cameras is not limited to four, and therefore the image recognition system 100 can include at least two cameras, such as four or more cameras.

The recognition processor 17 has implemented a single common recognition model for the four cameras 10-1 to 10-4. Alternatively, the recognition processor 17 can be comprised of a plurality of recognizers 17a (see phantom lines in FIG. 1); the recognizers 17a includes a first recognizer 17a using the common recognition model M. The recognizers 17a can be configured such that the output images output from the image generators 12-1 and 12-4 are input to the first recognizer 17a, and the output images output from the image generators 12-2 and 12-3 are input to another of the recognizers 17a.

As a modification, the recognizers 17a can each use the common recognition model M in accordance with plural target recognition purposes. For example, the output images successively output from the image generator 12-1 are used for the purpose of monitoring and preventing a collision of the vehicle V with other objects, such as a preceding vehicle or an oncoming vehicle, located in front of the vehicle V. At that time, the output image from the image generator 12-1 is configured to be input to one of the recognizers 17a.

In contrast, the output images from the image generators 12-2, 12-3, and 12-4 are used for the purpose of monitoring and preventing a collision of the vehicle V with other objects, such as vehicles approaching the vehicle V from the rear or the right or left side. The output images from the image generators 12-2, 12-3, and 12-4 are configured to be input to another one of the recognizers 17a.

This modification enables the frame rate for the front camera 10-1 to be set to be different from the frame rate for each of the right, left, and rear cameras 10-2 to 10-4.

That is, when the output images captured by the right, left, and rear cameras 10-2 to 10-4 at the same or similar frame rate, it is possible for the same recognizer 17a to perform recognition processing of the output images using a common recognition model.

Specifically, inputting the output image captured by the front camera 10-1 at a predetermined first frame rate to one of the recognizer 17a and inputting the output images captured by the right, left, and rear cameras 10-2 to 10-4 at the same or similar second frame rate that is lower than the first frame rate to another one of the recognizer 17a makes it possible to efficiently perform recognition processing of the output images captured by all the front to rear cameras 10-1 to 10-4.

The image recognition system 100 is configured to edit images captured based on respectively different directional view fields relative to the vehicle V such that the edited images respectively have adjusted angle-of-view resolutions while having the same size, and perform the recognition task of the edited images using the common recognition model M, but the present disclosure is not limited thereto.

Specifically, the image recognition system 100 can be configured to edit images captured by the same camera 10 such that the edited images respectively have different angle-of-view resolutions while having the same size, and perform the recognition task of the edited images using the common recognition model M.

The cameras 10-1 to 10-4 according to the present embodiment respectively include the optical systems that have the same configuration as one another, and respectively include the imaging sensors that have the same sizes as each other. However, the present disclosure is not limited thereto. Specifically, the cameras 10-1 to 10-4 can respectively include the optical systems that have different configurations from one another, and can respectively include the imaging sensors that have different sizes from each other. That is, the optical angles of view of the optical systems of the cameras 10 can be set to be different from each other.

The image recognition system 100 includes the image editors 11-1 to 11-4 configured to edit images captured by the respective cameras 10-1 to 10-4, but can include a common image editor configured to edit images captured by the respective cameras 10-1 to 10-4 to thereby generate edited images respectively have adjusted angle-of-view resolutions while having the same size.

Each of the image editors 11-1 to 11-4 is configured to thin the corresponding one of the clipping regions CR1 to CR4 to thereby adjust the size of the corresponding one of the edited images, but the present disclosure is not limited thereto. Specifically, each of the image editors 11-1 to 11-4 can be configured to perform one of known image interpolation algorithms, such as a nearest neighbor algorithm, a bilinear interpolation algorithm, a bicubic interpolation algorithm, or Lanczos interpolation algorithm to thereby adjust the size of the corresponding one of the edited images.

The clipping region specifying unit 13 according to the present embodiment specifies, as a clipping region, a part or the whole part of a captured image, but can specify a larger area of a captured image as a clipping region. In this modification, each image editor 11 can be configured to set each pixel of the larger part of the clipping region than the captured image to zero or to an average value of all pixel values of images for training the recognition model.

Each of the image generators 12 can be configured to dynamically change the size of the corresponding one of the output images, and the recognition processor 17 can also be configured to dynamically change the structure of the common recognition model. For example, each of the image generators 12 can be configured to dynamically change the size of the corresponding one of the output images depending on change of the speed of the vehicle V, and the recognition processor 17 can be similarly configured to dynamically change the structure of the common recognition model depending on change of the speed of the vehicle V.

For example, when the condition recognizer 16 recognizes that the vehicle V has a sufficiently slow speed, each of the image generators 12 can be configured to increase the size of the corresponding one of the output images. Additionally, when the condition recognizer 16 recognizes that the vehicle V has a sufficiently slow speed, the recognition processor 17 can be configured to change the structure of the common recognition model such that the changed structure of the common recognition model increases the number of computations to thereby enable higher accuracy of recognition of images.

The functions of one element in the above embodiment can be distributed as plural elements, and the functions that plural elements have can be combined into fewer elements. At least part of the structure of the above embodiment can be replaced with a known structure having the same function as the at least part of the structure of the embodiment. A part of the structure of the above embodiment can be eliminated. All aspects included in the technological ideas specified by the language employed by the claims constitute embodiments of the present disclosure.

While the illustrative embodiment and its modifications of the present disclosure have been described herein, the present disclosure is not limited to the embodiments and their modifications described herein. Specifically, the present disclosure includes any and all embodiments having modifications, omissions, combinations (e.g., of aspects across various embodiments), adaptations and/or alternations as would be appreciated by those in the art based on the present disclosure. The limitations in the claims are to be interpreted broadly based on the language employed in the claims and not limited to examples described in the present specification or during the prosecution of the application, which examples are to be construed as non-exclusive.

What is claimed is:

1. An image recognition system comprising:
a first image generator configured to generate a first image based on a first directional view field, the first image having a first angle of view and a predetermined size;
a second image generator configured to generate a second image based on a second directional view field at least partly different from the first directional view field, the second image having a second angle of view and the same predetermined size; and
a recognition processor configured to perform a recognition task of each of the first and second images using a common recognition model for the first and second images.

2. The image recognition system according to claim 1, further comprising a determiner configured to determine a first angle-of-view resolution of the first image generator,
wherein the first image generator comprises:
a first camera configured to capture a first base image based on the first directional view field; and
a first image editor configured to edit the first base image in accordance with the first angle-of-view resolution to thereby generate the first image.

3. The image recognition system according to claim 2, wherein:
the determiner comprises:
a clipping region specifier configured to specify a first clipping region corresponding to the first angle of view for the first base image; and
a reduction ratio calculator configured to calculate, based on the first clipping region, a first pixel reduction ratio for the first clipping region, the first pixel reduction ratio representing the ratio of the number of pixels to be reduced from the first clipping region to all pixels of the first clipping region; and
the first image editor is configured to:
clip, from the first base image, the first clipping region; and
reduce, based on the first pixel reduction ratio, the number of pixels of the first clipping region to thereby generate the first image.

4. The image recognition system according to claim 3, wherein:
the determiner is further configured to determine a second angle-of-view resolution of the second image generator; and
the second image generator comprises:
a second camera configured to capture a second base image based on the second directional view field; and
a second image editor configured to edit the second base image in accordance with the second angle-of-view resolution to thereby generate the second image.

5. The image recognition system according to claim 4, wherein:
the clipping region specifier is further configured to specify a second clipping region corresponding to the second angle of view for the second base image;
the reduction ratio calculator is further configured to calculate, based on the second clipping region, a second pixel reduction ratio for the second clipping region, the second pixel reduction ratio representing the ratio of the number of pixels to be reduced from the second clipping region to all pixels of the second clipping region; and
the second image editor is configured to:
clip, from the second base image, the second clipping region; and
reduce, based on the second pixel reduction ratio, the number of pixels of the second clipping region to thereby generate the second image that has the same predetermined size as the predetermined size of the first image.

6. The image recognition system according to claim 2, wherein:
the image recognition system is installed in a vehicle;
the image recognition system further comprising a condition recognizer configured to recognize at least one of an operating condition of the vehicle and an environmental condition around the vehicle; and
the determiner is configured to determine at least one of the first angle-of-view resolution and the second angle-of-view resolution in accordance with at least one of the operating condition of the vehicle and the environmental condition around the vehicle.

7. The image recognition system according to claim 6, wherein:
the condition recognizer is configured to recognize the environmental condition around the vehicle in accordance with a result of the recognition task of the recognition processor.

8. The image recognition system according to claim 6, wherein:
the condition recognizer is configured to recognize a speed of the vehicle as the operating condition of the vehicle; and
the determiner is configured to determine at least one of the first angle-of-view resolution and the second angle-of-view resolution in accordance with the speed of the vehicle.

9. The image recognition system according to claim 6, wherein:
the condition recognizer is configured to recognize where and how the vehicle is operating as at least one of the operating condition of the vehicle and the environmental condition around the vehicle; and
the determiner is configured to determine at least one of the first angle-of-view resolution and the second angle-of-view resolution in accordance with where and how the vehicle is operating.

10. An image recognition system comprising:
a first image generator configured to generate a first image based on a first directional view field, and output a first output signal including the first image, the first image having a first angle of view and a predetermined size;
a second image generator configured to generate a second image based on a second directional view field at least partly different from the first directional view field, and output a second output signal including the second image, the second image having a second angle of view and the same predetermined size; and
a recognition processor to which the first and second output signals are input, the recognition processor being configured to have a common recognition model for the first and second images.
